(19) United States
(12) Patent Application Publication
(10) Pub. No.: US 2015/0070897 A1
(43) Pub. Date: Mar. 12, 2015

(54) More Than One Level(s) LED Bulb Has Multiple Features

(71) Applicant: Tseng-Lu Chien, Walnut, CA (US)

(72) Inventor: Tseng-Lu Chien, Walnut, CA (US)

(21) Appl. No.: 14/289,968

(22) Filed: May 29, 2014

Related U.S. Application Data
(63) Continuation-in-part of application No. 14/280,865, filed on May 19, 2014.
Application No. 14/280,865 is a continuation of application No. 13/540,728, filed on Jul. 3, 2012, now Pat. No. 8,834,009.
Application No. 13/540,728 is a continuation-in-part of application No. 13/296,460, filed on Nov. 15, 2011, now Pat. No. 8,812,517.
Application No. 13/296,460 is a continuation-in-part of application No. 13/296,469, filed on Nov. 15, 2011, now Pat. No. 8,711,216.
Application No. 13/296,469 is a continuation-in-part of application No. 13/296,469, filed on Nov. 15, 2011, now Pat. No. 8,711,216.

(51) Int. Cl. F21V 14/02; F21V 14/00; F21V 23/00

(52) U.S. Cl. CPC F21V 14/02; F21V 23/008; F21V 14/003; F21Y 2101/02
USPC 362/269

(57) ABSTRACT

The current invention make a big improvement than conventional market all kind of LED bulb which only can offer near-by areas illumination, The current invention (1) has more than one movable level(s) can change position by variety choice of moveable-means (2) can offer near-by and far-away illumination, image, both, any combination with other light effects or digital data display images, Or (3) has more than one light beam emit out from LED bulb which under more than one control means, Or (4) has more than one function to emit light beam may selected from power failure, remote control, Infra red controller, blue-tooth means, wifi means, internet means, App software, motion sensor to trigger at least one of the light beam to offer illumination or image.

This application is a continuation-in-part of U.S. patent application Ser. No. 14/280,865, filed May 19, 2014, which is a continuation of U.S. patent application Ser. No. 13/540,728, filed Jul. 3, 2013, now allowed.

### DESCRIPTION

The current filing is Continue of U.S. Ser. No. 13/540,728 LED Bulb now is allowanced and issue fee paid before May 19, 2014.

This filing also is continue of U.S. Ser. No. 13/______ LED Bulb (# QQQ-1) which filed on May 10, 2014 as child patent of U.S. Ser. No. 13/540,728 for LED Bulb.

The current invention is Continuously or Division filing for co-pending filing case as below which NOT ONLY for parent filing features including (1) Project light (2) More than one function (3) adjust focus (4) adjust angle (5) Elastic contact points (6) LED heat solution (7) Heat sensitive parts installation (8) extend means BUT ALSO including new features (a) has movable-means to allow the at least one of level of the more than one lever LED bulb can move the desire level(s) away from original position, location, orientation to overcome all the interfere block-means so the said LED bulb can solve the (a) heat issue from LED(s) or circuit or electric components (b) lamp shade metal frame's block out the LED bulb light beam traveling (c) glass or metal or cement block means to block out the electric signals transmit from Bluetooth means, wifi means, internet means, App software means or any other electric wave-signals transmitting to control the said LED bub and its related electric parts or accessories.

Hereafter disclosure all below listed co-pending and patented as prior arts still fall within the current invention as below:

U.S. Ser. No. 13/367,758, U.S. Ser. No. 13/367,687, U.S. Ser. No. 13/296,508, U.S. Ser. No. 13/295,301, U.S. Ser. No. 13/021,107, U.S. Ser. No. 12/950,017, U.S. Ser. No. 12/938,564, U.S. Ser. No. 12/886,832, U.S. Ser. No. 12/876,507, U.S. Ser. No. 12/771,003, U.S. Ser. No. 13/021,124, U.S. Ser. No. 12/624,621, U.S. Ser. No. 12/622,000, U.S. Ser. No. 12/318,470, U.S. Ser. No. 12/914,584, U.S. Ser. No. 12/834,435, U.S. Ser. No. 12/292,153. U.S. Ser. No. 12/907,443, U.S. Ser. No. 12/232,505, U.S. Ser. No. 11/806,711, U.S. Ser. No. 11/806,285.

The current invention is Continue filing for Ser. No. 13/295,301 “The Device has build-in Digital Data means and Powered by unlimited power source of light device”.

The current invention is Continue filing for Ser. No. 13/296,508 “The Device has build-in Digital Data means and power unlimited power source of LED Bulb”

The current invention is continuously filing for Ser. No. 13/296,460 “The device has build-in Digital data means and powered by unlimited power source of Lamp Holder.

These (3) co-pending filing are Continuously filing of Ser. No. 12/951,501 “Lamp Holder has build-in LED Night light”

The current invention is continuously filing for Ser. No. 12/950,017 “Multiple surface LED light”

All these are Continuously filing for Ser. Nos. 13/296,508, 13/295,301, 13/296,469 are continuously filing for Ser. No. 13/162,824 Light device with display means has track-means and removable LED-unit(s) which are the continuously filing for Ser. No. 12/938,628 LED light fixture has outlet(s) and removable LED unit(s) and for Ser. No. 12/887,700 Light fixture with self-power removable LED unit(s). Those are continuously filing for Ser. No. 12/149,963(Now patented U.S. Pat. No. 7,722,230), Ser. No. 12/073,095 (Now patented U.S. Pat. No. 7,726,869), Ser. No. 12/073,889 (Co-Pending Filing), Ser. No. 12/007,076 (Now patented U.S. Pat. No. 7,726,841), Ser. No. 12/003,691 (Now Patented U.S. Pat. No. 7,726,839), Ser. No. 12/894,865 (Co-Pending Filing).

This is continuation of U.S. patent application Ser. Nos. 12/624,621, 12/622,100, 12/318,471, 12/318,470, 12/318,473, 12/292,153, 12/232,505, 12/232,035, 12/149,963, 12/149,964, 12/073,095, 12/073,889, 12/007,076, 12/003,691, 12/003,809, 11/806,711, 11/806,285, 11/806,284, 11/566,322, 11/527,628, 11/527,629, 11/498,874, 12/545,992, 12/806,711, 12/806,285, 12/806,284, 12/566,322, 12/527,628, 12/527,629, 12/527,631, 12/502,661, 11/498,881, 11/255,981, 11/184,771, 11/152,063, 11/094,215, 11/092,742, 11/092,741, 11/094,156. 11/094,155. 10/954,189, 10/902,123, 10/883,719, 10/883,747, 10/341,519, 12/545,992, 12/292,580, 12/710,918, 12/624,621, 12/622,000, 12/318,471, 12/318,470, 12/318,473, 12/292,153, 12/710,561, 12/710,918, 12/711,456, 12/771,003

This is Division of U.S. patent application Ser No. 13/______ field on Nov. 11, 2011 for The Device has build-in digital data means and powered by unlimited power source for Lamp Holder.

This is Division of U.S. patent application Ser. No. 13/______ field on Nov. 11, 2011 for The Device has build-in digital data means and powered by unlimited power source for light Device.

This is continuously of U.S. patent application Ser. No. 12/951,501 field on Nov. 20, 2010 for Lamp Holder has build-in LED light.

This is continuously of U.S. patent application Ser. No. 12/771,003 field on Apr. 29, 2010 for LED light has geometric-unit 9s) incorporated project means.

This is continuously of U.S. patent application Ser. No. 12/711,456 Field on Feb. 25, 2010 for LED power failure Light

This is continuously of U.S. patent application Ser. No. 12/710,561 Field on Feb. 25, 2010 for LED light device has special effects

This is continuously filing of U.S. patent application Ser. No. 12/710,918 Field on Feb. 25, 2010 for LED light device has more than 1 reflective means for plurality of image

This is continuation of U.S. patent application Ser. No. 12/624,621 Field on Nov. 24, 2009 file for the “project device or assembly for variety of LED light”

This is continuation of U.S. patent application Ser. No. 12/622,000 Field on Nov. 24, 2009 file for the “Interchangeable Universal Kits for all LED light”

This is continuation of U.S. patent application Ser. No. 12/318,471 Field Dec. 30, 2008 file for the “LED night light with pinhole imaging”

This is continuation of U.S. patent application Ser. No. 12/318,470 Field Dec. 24, 2008 file for the “LED night light with Projection features”

This is continuation of U.S. patent application Ser. No. 12/318,473 Field Dec. 8, 2008 file for the “LED night light with laser or hologram element”

This is continuation of U.S. patent application Ser. No. 12/292,153 Field Nov. 8, 2008 file for the “LED night light with Projection or imaging features”

This is continuation of U.S. patent application Ser. No. 12/232,505 Field Sep. 16, 2008 file for the “LED night light with Projection features”

This is continuation of U.S. patent application Ser. No. 12/149,963 Filed on Apr. 21, 2008 file for the “Removable LED light device.

This is continuation of U.S. patent application Ser. No. 12/149,964 Filed on Apr. 21, 2008 file for the “Surface Mounted Device with LED light”.

This is continuation of U.S. patent application Ser. No. 12/073,095 Filed on Feb. 29, 2008 file for the “LED Track light device.

This is Continuation of U.S. patent application Ser. No. 12/073,889, filed on Feb. 12, 2008 file for the “LED light with changeable position with Preferable power source”.

This is Continuation of U.S. patent application Ser. No. 12/007,076, filed on Jan. 7, 2008 file for the “LED light with changeable geometric system”

This is Continuation of U.S. patent application which the Ser. No. 12/003,691, filed on Dec. 31, 2007 file for the “LED light with changeable geometric dimension features”

This is Continuation of U.S. patent application which the Ser. No. 12/003,809, filed on Jan. 2, 2008 file for the “LED light with changeable features”

This is Continuation of U.S. patent application which the Ser. No. 11/806,711 filed on Apr. 30, 2007 file for the “Multiple LED light with adjustable angle features”

This application is continuation of U.S. patent application Ser. No. 11/806,285. LED Night light with outlet device filed on Apr. 30, 2007

This application is continuation of U.S. patent application Ser. No. 11/806,284 LED Night light with more than 1 optics means filed on Apr. 28, 2007

This application is continuation of U.S. patent application Ser. No. 11/527,628. Multiple function Night light with air fresher filed on Sep. 27, 2006.

This application is continuation of U.S. patent application Ser. No. 11/527,629. LED Night light with interchangeable display unit filed on Sep. 27, 2006.

This application is continuation of U.S. patent application Ser. No. 11/498,874. Area illumination Night light filed on Aug. 4, 2006.

This application is continuation of U.S. patent application Ser. No. 11/527,631. LED Time piece night light field on Sep. 27, 2006.

This application is continuation of U.S. patent application Ser. No. 12/545,992 LED time piece Night light filed division of Ser. No. 11/527,631 on Aug. 24, 2009.

This application is continuation of U.S. patent application Ser. No. 12/292,580 LED Time Piece Night light filed division of Ser. No. 11/527,631 on Aug. 24, 2009.

This application is continuation of U.S. patent application of Ser. No. 11/498,881, Poly Night light filed on Aug. 4, 2006.

This application is continuation of U.S. patent application of Ser. No. 11/255,981, Multiple light source Night Light filed on Oct. 24, 2005.

This application is continuation of U.S. patent application of Ser. No. 11/184,771 Light Device with EL elements field on Oct. 11, 2005

This application is continuation of U.S. patent application of Ser. No. 11/1152,063 Outlet adaptor with EL field on Jun. 5, 2005

This application is continuation of U.S. patent application of Ser. No. 11/094,215 LED night light with liquid medium filed on Mar. 31, 2005

This application is continuation of U.S. patent application Ser. No. 11/094,215, filed Mar. 30, 2005 LED Night light with Liquid optics medium.

This application is continuation of U.S. patent application Ser. No. 11/092,741, filed Mar. 30, 2005 Night light with fiber optics.

This application is continuation of U.S. patent application Ser. No. 10/883,747, filed Jul. 6, 2004 Fiber Optic light kits for footwear.

This application is continuation of U.S. patent application Ser. No. 11/498,874, Area Illumination for LED night light

This application is continuation of U.S. patent application Ser. No. 11/527,629. Time Piece with LED night light,

This application is continuation of U.S. patent application Ser. No. 11/527,628. Multiple Function Night light with Air Freshener

This application is continuation of U.S. patent application Ser. No. 11/806,284 LED Night light with more than one optics mediums

This application is continuation of U.S. patent application Ser. No. 11/806,285 LED Night Light with multiple functions

This application is continuation of U.S. patent application Ser. No. 11/806,711 Multiple LEDs Light with adjustable angle function

The current invention incorporate with above listed co-pending or patented cases' features, construction still fall within the current inventions scope and all related equivalent function or replace parts also should fall within the current invention.

### BACKGROUND

The current invention for LED bulb has at least one level and its movable means to make the at least one level of the said LED Bulb can change the position, location, orientation away from original position while need to make desire light functions, performance, effect.

The at least one of the level (or parts or accessories) incorporate with movable-means so can move the at least one of level (including parts or accessories) away from original position, location, orientation so can overcome some block-means which affect or interfere the LED bulb desire functions.

Such as the current invention's more than one level(s) LED bulb, The top part is a project light functions but while it install on all desk lamp, floor lamp, down light, indoor lighting or outdoor lighting will have lamp shade problem because some of lamp shade has metal frame and ring on the center line of the LED bulb's and lamp socket. So if the LED bulb has no movable level(s), the top part project light's image will be block out by the lamp shade's metal frame and metal rings to destroy the project image performance. The current invention solve this issue and let the top part of the LED project light can move away from the said Lamp shade's metal frame and metal ring so can let the LED project beam pass though no block-means area and create the image/message/time/digital data/digital image/LCD display image/arts on the desired ceiling surface. If use traditional LED project Bulb, the lamp shade block-means will totally destroy the LED project light performance.

The current invention also can solve the heat issues of all market available LED Bulb. The simple solution is let the LED(s) and electric parts, accessories, components all located on the base part of the said more than one level(s) LED bulb or at least one level of the LED bulb to has the movable-means which including all kind of moving parts which may including spin, rotate, hinge, arms, joint piece, join pieces, extendable, extractable means to make the heat source away from the other part.

For example if the said more than one level(s) LED Bulb, (1) Same as parent filing→all electric parts may put on Top part so all heat will move to top areas OR (2) Same as current invention some preferred embodiment drawings to show→all the electric parts put on the base part and move the top parts away from heat upper area so the heat will not affect to the other parts. The both solution has use the movable-means from extractable means, extend means, movable parts or accessories, rotate means, pole means, hinge means, arm means, bar means, snake-house means or whatever the means can move the parts to other location so can easily to overcome the heat issues.

The current invention LED bulb also good for LED Bulb for upper or down installation because has the movable-means including extractable means, extendable means which can overcome the down light application because some down light (LED Bulb base face sky) has lamp shade which made of glass, metal, cement, concrete surrounding the said Down light or recess light installation so these electric-signal block-means will affect, interfere the electric signal transmitting so let Bluetooth control, Wifi control, remote control, infra-red control, internet control, App software control loose or reduce or limited the signal transmitting to let these functions become a problem. So the current invention has all proper movable-means help to overcome these electric signal block means and make the LED bulb has its designed and pre-determined functions without any affect or interfere or limited by the said electric-signal block-means.

The current invention has more than one level(s) (including parts and accessories) LED bulb which each level can has its own functions or multiple functions control by market available skill or method may selected from Blue-tooth, Wifi, internet, App software, IC, Remote signal, infra-red signal, motion sensor, heat sensor though computer, communication, consumer device by people. Such as the more than one levels LED Bulb has (1) Multiple colors with changeable colors and moving effects (2) Multiple functions select from market available any LED light effects for indoor and outdoor lighting (3) Multiple control means which select from market available control, sensor, switch, blue-tooth, wifi, internet, app software, remote, infra-red or other electric or electronic related circuit or device(s) (4) More than one movable-means (5) Changeable geometric shape (6) Changeable construction (7) moveable means select from any group combination from bar, pole, spin, rotate, hinge, arms, joints, join, frame, connector, sections to make the levels, parts, accessories to be move away to desire location, positions. These are the main features of the current invention.

The current invention mainly for LED bulb which has following other features as parent filing case stated as below:

1. The current invention which the said LED Bulb has property that the LED bulb can have more twist degree or twist angle after LED Bulb's contact-Point touched electrode—This features can get horizon more than 360 degree to let the light beam to position the certain area(s) to get more wider of adjust angle and more wider of adjust directions and it also can incorporated with adjustable Focus means to make the same of LED light beams or image to shown different light performance on the desired locations or area(s). The Rotatable LED Ball with two arms to offer the said LED Bulb of preferable Geometric shape and construction, can adjust angle in vertical axis up to more than 360 degree angle so can get the LED Bulb's plurality of light beams can cover all x-y-z axis areas by at least one of light beam or plurality of the light beam to illuminate the near-by or far-away or remote-away or any combination of the said LED Bulb. (Lamp holder co-pending).
2. The current invention which the said LED Bulb has One or more than one of the light beams arrange in LED bulb for desire light performance. As co-pending filing content which has more than one LED light source(s) are for Night light, more than on project assembly for project LED lighting. The current invention can create same light performance as the co-pending or patented applications as attached drawings, the difference than prior-arts with night light because Night light has prong means and for outlets installation and not have extend/retractable means.
3. The current invention which the said LED Bulb has Focus adjustable means so can make same light beam emit out from same LED bulb to wherever surface(s) with desired light performance with brightness, size, light spots, color, lit-areas. The same light beam output from same LED Bulb with focus adjustable means can create the different light pattern, light path, light brightness, light performance, light direction, light performance by viewer.
4. The current invention which the said LED Bulb has extendable means such as extend tube, telescope tube or equivalent extendable, receivable means which can make the electric parts & accessories etc. of LED bulb keep away from LED(s)'s heat, block-means of lighting's curtain, lighting's shade, lighting's glass, cylinder tube of recess lighting, or other block-means which block the motion-sensor lens, remote control signal, or light beam emit direction. To keep the said LED bulb's related Circuit board/control means/IC means/switch means/sensor means/electric parts or assembly means—Away from the LED-units or block-means to prevent from heat affect the desire functions, performance, such as Motion sensor or PIR sensor head or Fresnel lens or LED-unit light beam emit direction.
5. The current invention which the said LED Bulb has Extractable/extendable/movable means to put heat sensitive or light sensitive parts away from LEDs' heat, light's shade, light's curtain, light's glass, decorative material, ceiling block means, or any other block means which will interfere the LED bulb or LED Bulb's related parts & accessories. The said extendable or extractable means preferred to design on front of the LED bulb, but it depend on the different requirement and different consideration of heat, block-means which offer the more space to install the preferred electric parts & accessories, offer the extra length to far-away from heat means or block-means so the LED bulb can overcome heat and block-means for any applications, installation.
6. The current invention is different from all market available LED Bulb which offer The illumination only cover the adjacent area which are start from the LED Bulb to certain distance (illumination surrounding LED Bulb or start from LED bulb to certain distance with illumination) and do not offer the illumination or image to a area(s) which has certain direction(s), angle(s), distance(s) which far away or remote-away from the LED Bulb. The current invention can make any combination to offer the near-by areas illumination, far-away areas illumination or together for both illumination effects.
7. The current invention which the said LED Bulb has more than one light beams output to different area(s), direction(s), location(s) and make more than one years with illuminations which all these areas may not adjacent, link, sit together. The said LED bulb may offer more than one area(s) have illumination is other features of current other features which can allow people to make the energy saving and only offer illumination for where needed such as Stair lighting which only Up or Down two direction need illumination to see stairs. Rest areas no need the light at all and the said stair-lighting has Build in Motion Sensor has sensitivity up to 10-30 feet is enough to cover one floor stairs (Normally is 18 steps). One light beam for LED bulb to emit up 9 steps and one light beam of same LED bulb to emit down 9 steps. This will be enough illumination because each UP or DOWN stair are been illuminated by each Floor's one LED Bulb, so 2 different of light beam(s) to offer same one UP or One Down 9 steps . . . . This is pretty good power saving device while motion sensor device build-in more than one of light beam as output from one LED bulb.

Hence, the current invention can has at least one or plurality of light beam output from one LED bulb to near-by area(s), remote-away area(s), far-away area(s) or any combination of these area(s) with adjust angle, adjust focus, elastic contact-point, rotate/spin/tilt frame or support or base to get desire direction to emit light beam, extend/retractable means to install all parts & accessories away from heat or block-means are all belong to current invention features so can let all light beam to emit to area(s) where need the illumination, Not like conventional LED bulb only can supply the near-by area(s) which start from the LED-bulb to certain limited distance areas (LED bulb has limited brightness to emit to long distance except like current invention to apply optics lens or lens assembly to project light beams to remote-away or far-away distance which current market items can not create.)

### DRAWINGS

FIG. 1A and FIG. 1B and FIG. 1C: Disclosure the 1^{st} embodiment of the said LED Bulb main construction has geometric shape unit and has more than one levels (Parts or accessories) can be move to desire locations, place, by movable-means to get desire LED bulb function, performance, effects. It may also has two movable arms to join with body (preferred any shape design) to make the geometric can have more than 360 degree rotate or adjust angle or change position. The base is in a form of the screw base of male type to assembly with female receiving parts for power.

FIG. 2A and FIG. 2B and FIG. 2C and FIG. 2D: Disclosure the 1^{st} embodiment of the said LED bulb apply for desk or floor lamp examples. The LED Bulb will meet the Lamp Shade block-means on top or side metal frames and center ring which will block out the LED bulb light beams to form a shadow while light passing though the metal frame or center rings.

FIG. 3A and FIG. 3B: Disclosure the other embodiment of the said LED bulb apply for down light, or entrance light, stair light, recess light applications which may has the block-means from the ceiling, walls, lamp shade which made of cement, concrete, metal, porcelain, pottery or any material which will block out the electric wave, electric signal to transmit though to affect or interfere the LED Bulb operated by Wifi, Blue-tooth, internet, App software electric signal delivery so the current invention has moveable-means such as retractable, extendable, spin, rotate, moving arms, snake house, hinge to move the LED Bulb's at least one level(s) away from (a) Heat (b) light traveling (c) electric signal transmitting (d) all other block-means related to the said LED.

FIG. 3C and FIG. 3d: Disclosure the show drawing for other block means and the extractable or extendable movable-means for the said LED bulb as parent filing case.

FIG. 4a and FIG. 4b, FIG. 4c, FIG. 4d, FIG. 4e disclosure the current invention for more than one Level(s) LED bulb has its movable-means to make the one LED bulb to change to vaviable geometric shapes as needed. The each level may has its preferred light functions and added other any functions. Each level also can has its own control means, sensor means, switch means, IC, circuit, LED(s), Optics means, laser means, project means, blue-tooth, wifi, internet, app software to make the said LED bulb can has more than one functions selected from all lighting functions available from market place including power fail, emergency light, accent light, garden light, project light, advertisement light, seasonal light, remote control light, infra-red light, sensor light or any combinations for preferred multiple functions of LED or LED(s) light features, functions, effects, performance.

FIG. 5a and FIG. 5b and FIG. 5c and FIG. 5d and FIG. 6a and FIG. 6b and FIG. 6c disclosure the different more than one level(s) LED bulb has its own movable-means to move at least one level's parts or accessories away from original locations to desire location, place, orientations. The LED bulb can be any geometric shape and at number of level(s) needed. Each level has its preferred one or more than one electric or electronic functions select from market place.

FIG. 7a and FIG. 7b and FIG. 7c disclosure the snake-house or joint-piece construction moveable-means to work different LED bulb such as the 7a as separate piece for snake-house with LED bulb or FIG. 7b the LED bulb has the built-in snake-house base. The FIG. 7c show the built-in snake base has the LED bulb one level been move away from center line to overcome the lamp-shade block means.

FIG. 8a and FIG. 8b and FIG. 8c and FIG. 8d disclosure the movable-means in the form of the movable arms, rob, joint, bar, tube, pole to make the at least one of level's parts and accessories for position, location, orientation changed to desire location, position, orientation. Also show the More than One level(s) LED bulb may has top part and middle part and base part or further has 2^{nd} parts, 3^{rd} parts, 4^{th} parts . . . etc.

FIG. 9a and FIG. 9b and FIG. 9c and FIG. 9d disclosure more alternative and preferred geometric shape of LED bulb and everyone has more than one levels and has desire level or level(s) can be movable to any location, position, orientation while people needed by the said variety or plurality of the said different type of movable-means.

The current inventions all drawing are same as above listed co-inventor co-pending or patent drawing with some change on the LED bulb has more than one level(s) and use more than one movable-means can make the at least one level's parts or accessories to any desire location, position and orientation. Also, Each level(s) can has one or more than one flight functions selected from market available LED or LED(s) light effects, function, performance. So it is easily to refer all these concept is same but belong to brand new while become the LED bulb applications with all prior arts features and concept. It is appreciated all listed co-pending or patented drawing, concept, feature or equivalent or same functions parts/accessories/electric circuit/concept still fall within the current invention for LED BULB application.

### DETAIL DESCRIPTION

From the above background and drawing discussion, The current invention make a big improvement than conventional market available all kind of LED bulb which only can offer near-by areas illumination not like the current invention NOT ONLY has more than one levels, parts, accessories can change position by moveable-means to make the inventor's LED Bulb can overcome all kind of block-means which may happened by (a) heat created by LED(s) or its circuit, electric components (b) light beam block means to affect or interfere light traveling (c) signal block means to affect or interfere all kind of electric signal transmitting (d) other block means to destroy the said LED desire functions, performance, effects BUT ALSO inventor's LED bulb can use one LED bulb to offer near-by and far-away illumination or image or both and the said LED bulb also can has other features such as (1) Multiple colors with changeable colors and moving effects (2) Multiple functions select from market available any LED light effects for indoor and outdoor lighting (3) Multiple control means which select from market available control, sensor, switch, blue-tooth, wifi, internet, app software, remote, infra-red or other electric or electronic related circuit or device(s) (4) More than one movable-means (5) Changeable geometric shape (6) Changeable construction (7) moveable means select from any group combination from bar, pole, spin, rotate, hinge, arms, joints, join, frame, connector, sections to make the levels, parts, accessories to be move away to desire location, positions. These are the main features of the current invention.

The said LED Bulb has more than one level(s) and has desire level(s) can change position, location, orientation to overcome any block-means to get the desire LED Bulb functions by variety type of moveable-means.

Also, The current invention may has more than one light beam emit out from LED bulb which under more than one control means for the one of the light beam may selected from power failure, remote control, Infra red controller, blue-tooth with mobile phone, Wifi, internet control, app software control, motion sensor to trigger at least one of the light beam to offer the light beam for illumination or image to area(s).

Also, the other (16) features as below listed:

Features 1: The LED bulb has consist of:
At least one LED(s) as light source of said LED bulb which emit light beam to desire areas, locations with predetermined illumination, function, time period, performance.
The said LED bulb has parts or accessories for desire group combination select from optic means, lens, adjustable focus means, twisted means, rotate means, elastic contact end, more than one output light beam(s), rotating frame, bulb shade with arms for rotating/tile, more twist bulb base, support for shade, LED assembly, LED tubular means, adjust means, project means, digital data display means, Lcos display means, LCD display means, digital camera means, data storage means, data been projected by optics means, sensor means, switch means, IC means, circuit means, extend means, extractable means, filter means, stencil means, cutout means, painting means, motion sensor means, Remote control means, blue tooth means, Internet wireless means to make the said LED bulb emit the light beams, image, time, data, digital message, internet data(s) to desire near-by area(s) or remote-away distance area(s) for illumination.
The said LED bulb connect with power source by contact means of base in preferred construction and configuration and incorporate with electric parts & accessories to emit the light beam(s) to areas with adjustable angle cover preferred in x-y-z axis or any combination as required for preferred light performance, effects, functions.
The improvement including:
At one of the output light beam(s) from the said LED bulb can adjust direction to certain area(s), location(s), distance(s) while adjust above listed component(s) of said LED bulb.
The said base of LED bulb is mail insert means to fit into the female receiving means for desired construction.
The said LED Bulb at least has adjustable parts to make the said at least one of light beam can change position, direction, orientation.
   Features 2: The LED Bulb as above listed (Feature #1), the said elastic contact means which allow the said LED bulb can adjust the said at least one of the light beam can be position, location, direction to certain area(s) in x-y-z axis.
   Features 3: The LED Bulb as above listed (Feature #1), the said extendable, extractable means which is The parts can be extend away from the said LED Bulb and has certain configuration and construction to allow install some electric parts & accessories, sensor means, motion sensor means, remote control means, heat sensitive means within so can over come heat, light's shade, light's lens, light's curtain, light's glass, light's cover, cavity's depth, or any other block means.
   Features 4: The LED Bulb as above listed (Feature #1), the said same light beam can incorporate with Optics means, optics lens, optics lens assembly with parts & accessories to make the same light beam has different light performance.
   Features 5: The LED Bulb as above listed (Feature #1), the focus adjust means can make same light beam to present different light performance on the certain location, position, area for desire brightness, size, performance.
   Features 6: The LED Bulb as above listed (Feature #1), the said Bulb's frame, support means which offer the Bulb can be twist, tilt, rotate, spin, adjust angle and with hold means to overcome any heat issues to make the said change desired angle.
   Features 7: The LED Bulb as above listed (Feature #1), the said Base of LED bulb can be in any construction including screw type, pins type, poles type, multiple poles type, twist type, bayont type, conventional market type for current invention.
   Features 8: The LED Bulb as above listed (Feature #1), the said More than one light beam output(s) which means the said LED bulb has more than one of the light beam(s) are emit to the location(s), area(s), position(s) which is remote-away from the said LED Bulb.
   Features 9: The LED Bulb as above listed (Feature #1), the said LED assembly, LED tubular means, Project means the construction, parts & accessories which for LED light source so can make the certain LED(s) light beam do not leakage out and passing though the said optics means, optics lens, display unit, image, LCD display image, Lcos image, digital display can be emit out of said LED Bulb to get light beam or image to desire location, position, areas.
   Features 10: The LED Bulb as above listed (Feature #1), the said sensor means, switch means, motion sensor means, remote control means, blue tooth means, photo sensor means or other market available electric parts & accessories incorporate the circuit means to make the said LED light source to emit light under predetermined light function, performance, effects.
   Features 11: The LED Bulb as above listed (Feature #1), the said extend means, retractable means can install the select electric parts & accessories, also the LED light source depend on the LED bulb application including up or down or horizon arrangement.
   Features 12: The LED Bulb as above listed (Feature #1), the said LED Bulb can illuminate the areas including any combination of areas(s) which are near-by area(s), far-away area(s) or together for both near-by and far-away area(s) effects.
   Features 13: The LED Bulb as above listed (Feature #1), the said LED bulb has more than one functions not only offer the illumination for near-by area or remote-away distance area(s) but also may incorporate with motion sensor, remote control, blue-tooth for other functions.
   Features 14: The LED bulb consist of;
At least one LED bulb which has at least one LED(s) as light source to offer the illumination or image while the light source are connect with related circuit means, IC means, electric parts & accessories and related switch means, sensor means, remote control means, blue-tooth means or equivalent trigger means.
The said LED Bulb has extend means to install the electric parts & accessories, extra LED, sensor means, control means, RF receiving means, IR sensor means, or other equivalent control means to overcome the LED(s) heat, or surrounding block-means of lighting fixture's shade, cover, glass, frame, support, ceiling, wood piece, metal piece, plastic pieces.
The said extend means can extend to certain distance to away from LED(s) heat or any block-means to allow the light beams or electric signal delivery direction without interfere by surrounding heat and block-means to let said LED bulb can has pre-determined function(s), Performance(s), Effects(s).
   Feature 15: The LED bulb consist of:
At least one LED bulb which has at least one LED(s) as light source to offer the illumination or image while the light source are connect with related circuit means, IC means, electric parts & accessories and related switch means, sensor means, remote control means, blue-tooth means or equivalent trigger means.
The said LED bulb supply the illumination or image to a remote-away areas(s) by angle, position, orientation, direction, focus adjust means while incorporated with optics means, optics lens, project assembly, LED(s) assembly.
The said LED bulb emit the light beam to desire area(s) in preferred combination of near-by illumination, far-away illumination, near-by image, far-away image, digital data image, movie image, internet digital data image, time display, motion picture image, colorful image.
   Feature 16: The LED bulb consist of;
At least one LED bulb which has at least one LED(s) as light source to offer the illumination or image while the light source are connect with related circuit means, IC means, electric parts & accessories and related switch means, sensor means, remote control means, blue-tooth means or equivalent trigger means.
The said LED Bulb has more than one of light beam emit out from the said LED bulb for illumination or image.
At least one of the LED light beam are triggered by control means which may select from group combinations from motion sensor, remote control, Infra red sensor, Bluetooth means, power failure means & build in Direct current power storage means, sensor means, switch means, or other electric parts & accessories means.
The current invention has very details notes on each drawing so here do not discuss details, please refer to attached drawing with brief description below:

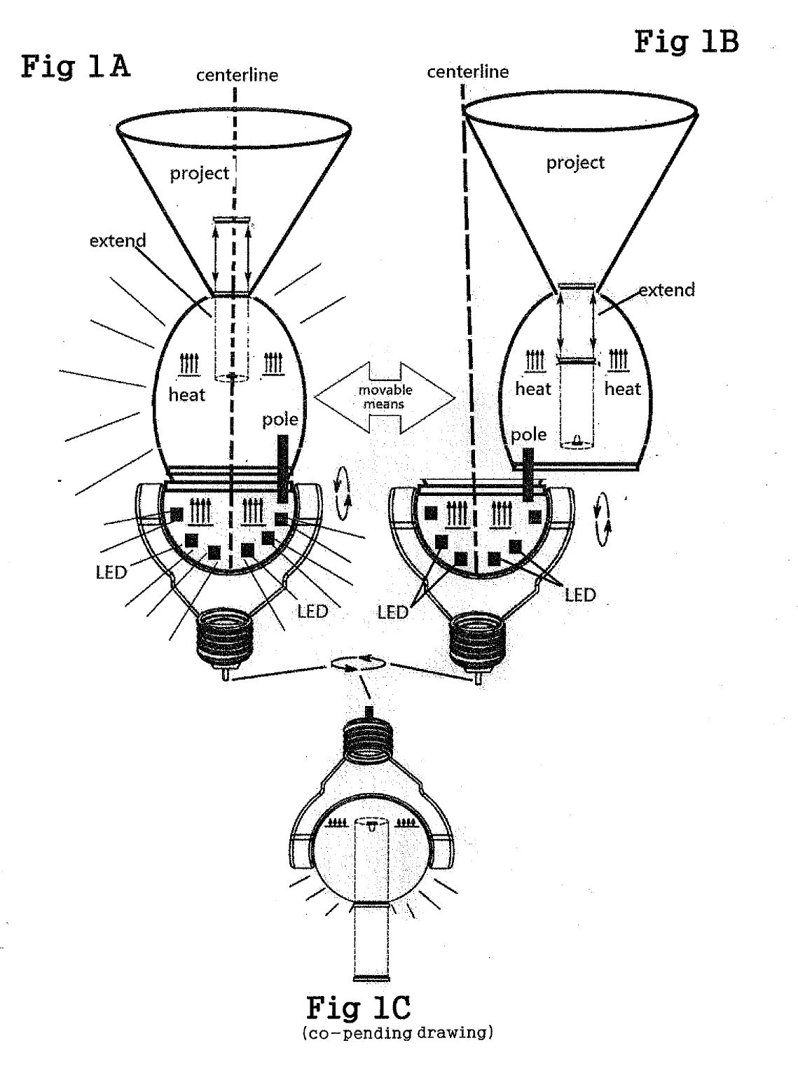

From FIG. 1a and FIG. 1b and FIG. 1c show the inventor's more than one level LED light which has at least one of the level can be move away from original location, position to overcome the block-means come from (a) heat block means from LED & circuits (b) block means affect the light traveling (c) block means affect the electric signal transmitting or any other block means to affect, interfere the desire light performance, effects, functions for the said more than one level LED bulb. The LED bulb has at least one of the moveable-means may select in group combination select from joint-means, join means, rotating means, spin means, hinge mean, bar, pole, connect means, arms, snake-house means, bend-n-shape means, twist means, extractable means, extendable means, foldable means or any market available skill or method to make the at least one of the level to change position, location, orientation in x-y-z axis to overcome the block-means which block the heat flow, the light beam traveling, the electric signals transmitting or other interfering block issues.

From FIG. 1a and FIG. 1b and FIG. 1c show the LED bulb at least one level not only can move to any location, place, orientation by moveable-means but also has the elastic contact base which can has twist more angle or circles after the elastic contact base already make electric-contact with the power source so the movable-means and elastic contact base both can make the LED bulb to get perfect location, place, orientation to get desire functions, performance, effects.

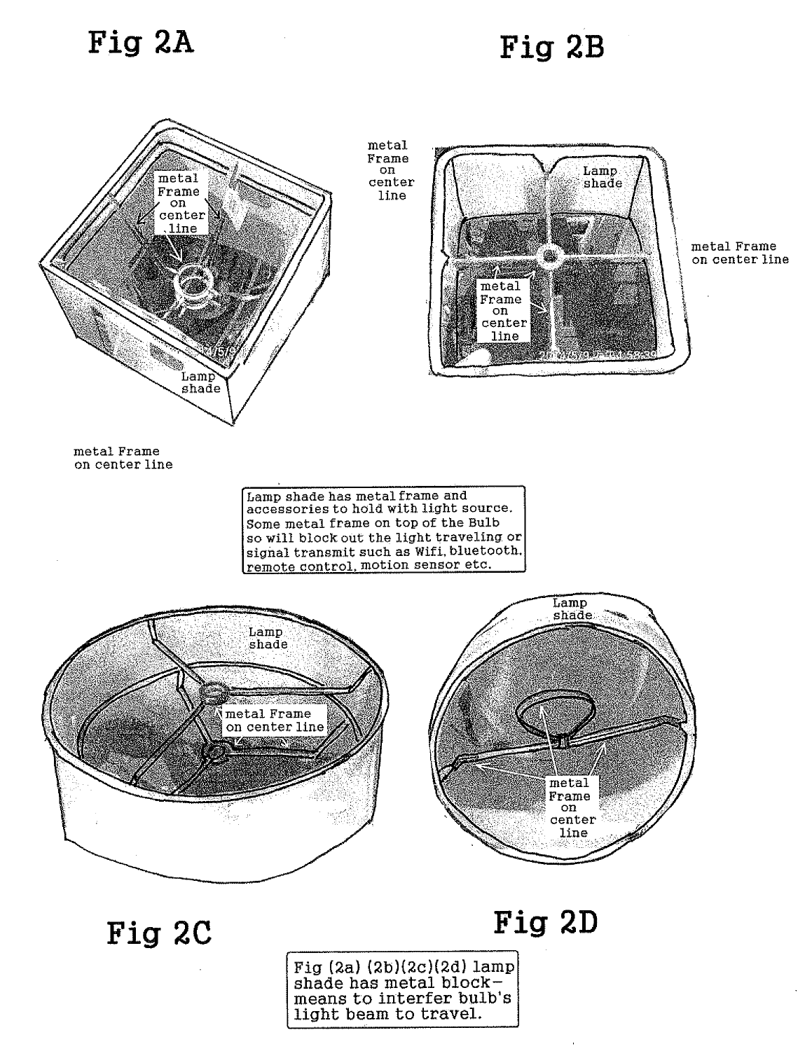

From FIG. 2a) (2b)(2c)(2d) lamp shade has metal block-means to interfere bulb's light beam to travel. The Lamp shade has metal frame and accessories to hold with light source. Some metal frame on top of the Bulb so will block out the light traveling or some shade made by the glass or metal or electric-block material will caused the electric signal can not be transmitted including Wifi, bluetooth, remote control, motion sensor etc so need has moveable-means to move the at least one part of the said LED bulb related part(s) away from block means to let the (a) heat can ventilated (b) light can traveling (c) Signal can be transmit.

From FIG. (3a)(3b)(3c)(3d) show other block-means which interfere light beam or signal or heat to transmit or delivery or traveling so moveable-means can make LED bulb's part(s) to move away from these block-means

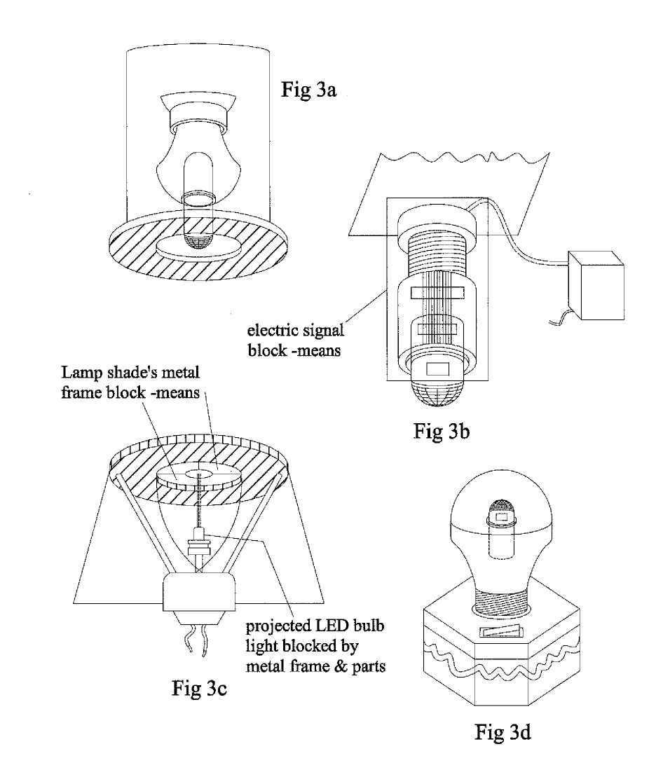

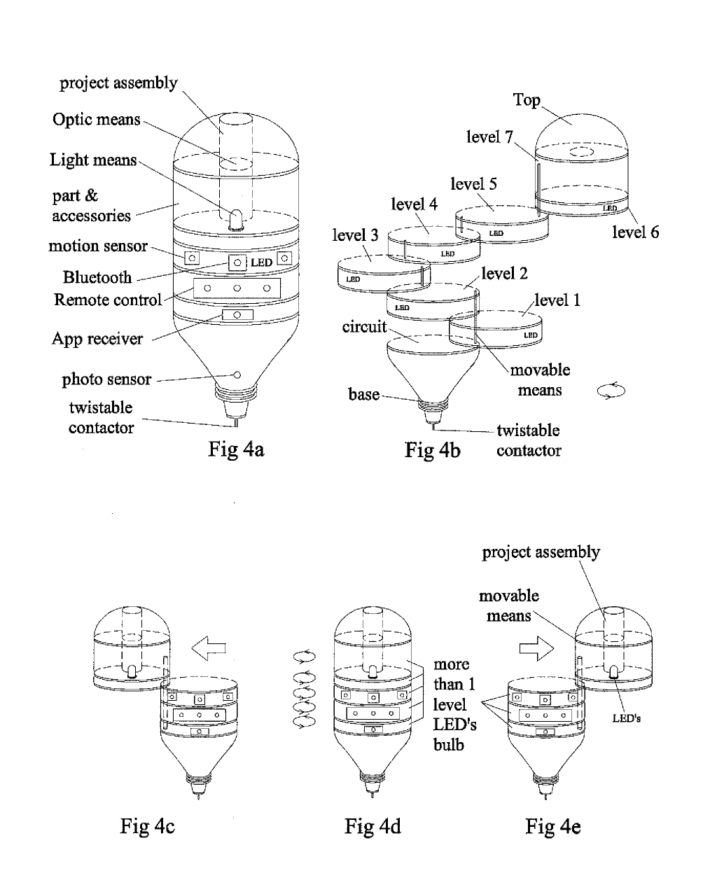

From FIG. 3(a) show LED bulb inside the Ceiling for down light and surrounded by ceiling or wall material. It may apply similar down-light construction for entrance door or some other stair or evacuation stair, parking lots, and building stairs . . . etc. At these applications the said Bulb is surrounded by cement, glass, metal shell, or some material which not allow the electric signal to pass so need has the inventor's LED bulb has moveable means to make at least one part of the LED bulb can be move and away from the Block means to allow user can get good light arrangement. It also show at FIG. 3a is a Recess light or down light applications which has the ceiling material which may is cement, metal, brick, glass, porcelain, pottery or any other material will interfere the electric signal such as Blue-tooth, Wifi, Remote, Infra-red, electric wave or electronic wave to transmit so need inventor's moveable-means to move at least one part of the LED bulb to away from all such market existing block-means so consumer can get inventor's LED bulb to replace the non-energy saving Incandescent bulb or other non-movable LED bulb for such applications.

From FIG. 3b show the one of preferred embodiment for down light application which The down light applications can see everywhere such as building stair, entrance door, evacuation stairs, Parking lots, public areas . . . etc. The Bulb has the glass or metal or some material which will interfere the light beam traveling or the electric signal transmit so need use inventor's LED bulb has movable-means to move at least one parts of the LED Bulb away from the all kind of block-means to get desired light functions.

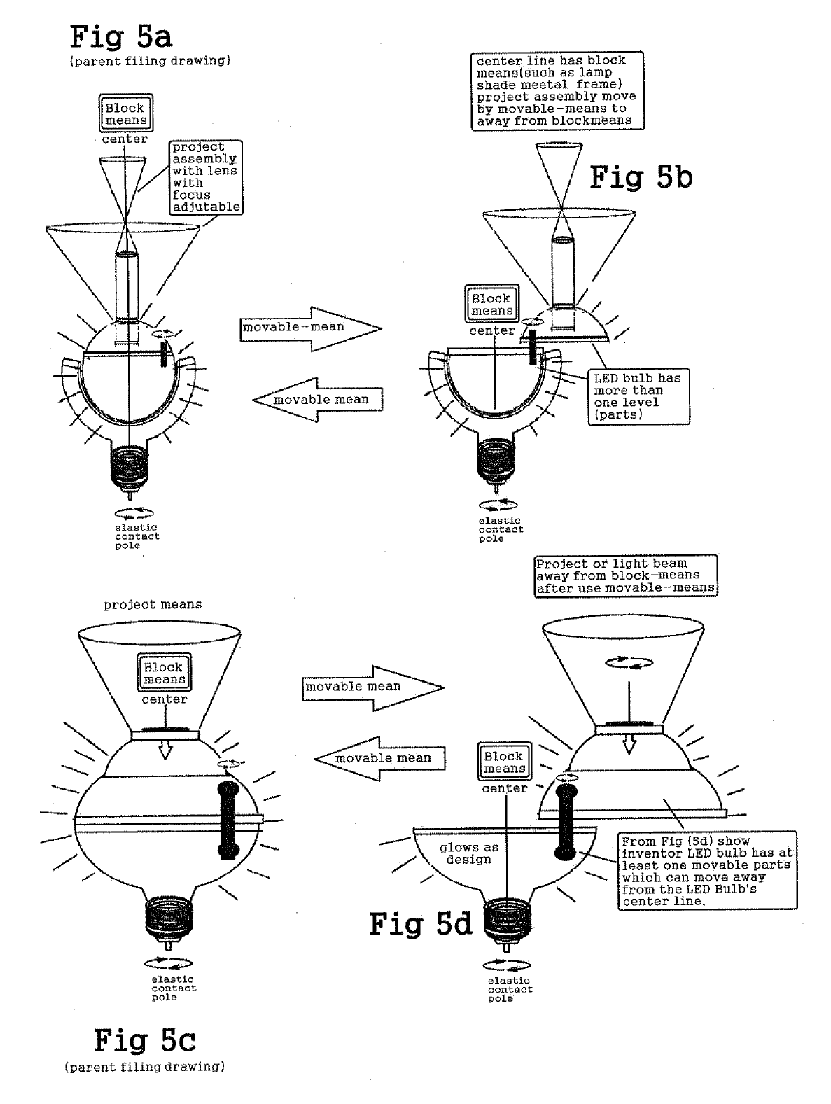

From FIG. 4a show the multiple functions LED bulb has desire combination functions select from multiple of color LEDs, more than on levels, blue tooth, wifi, Remote control, motion sensor, App receiver, CDS, all kind of sensor, switch, IC, receiver, trigger, time delay, automatically, manual or any other electric functions available from market place still fall within the current invention scope.

From FIG. 4b shown a LED bulb has more than one function as above FIG. 4a disclosure. From FIG. 4b also can see there has multiple levels for the said LED Bulb and each level has its own movable-means to make each level can rotating alone the said movable-means so can make each of the level to desired orientation, position, direction to (1) overcome the block-means or (2) make the desired light beam to desired locations, areas, distance by other technical means (3) make each of the level has different light function, color, brightness, turn-on/turn-off time, sensor means, control means, IC means to make any combinations for light functions which available from market place.

From FIG. 4b) show LED bulb (1) has more than 1 level/units (2) has more than 1 functions (3) has geometric shape changeable moveable means to overcome block-means for (a) heat (b) Light traveling (c) signal transmitting by market available skills may selected from hinge, bar, pole, rotating, spin, extractable, extend, snake house, . . . etc.

From FIG. 4c show the LED bulb has more than 1 levels and some level has (1) project assembly (2) Illumination LED(s) (3) control means (4) Remote, Blue-tooth, Wifi, App software receiver means.

From FIG. 4d) show LED bulb has more than 1 levels and desire level has movable-means to make the said level to change x-y-z location

From FIG. 4e shown the each level of LED bulb which has desire functions which may selected from market available Light source, sensor means, switch means, remote control, wifi, blue-tooth, App software and has movable-mean

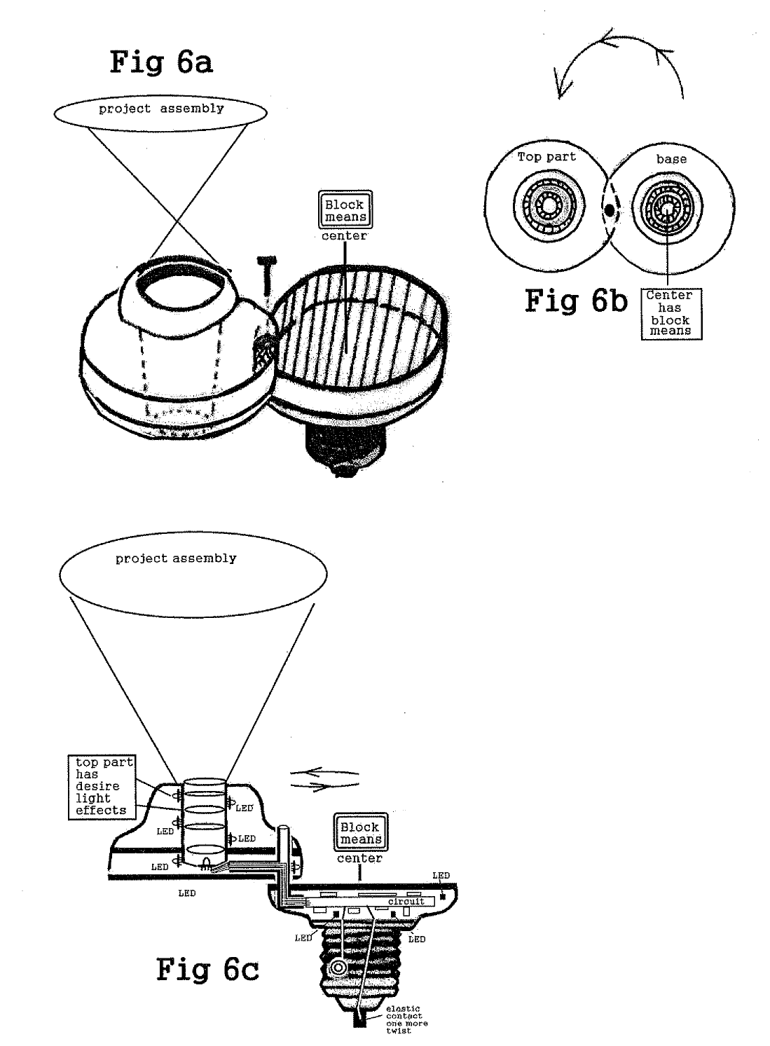

From FIG. 5a which is parent filing drawing has the center line from the base and top the center line of LED bulb has block-means such as lamp shade's metal frame so the invention's LED bulb has more than one of level so can use movable-means to move the top parts away from the center line to make the project light can away from block means. The inventor's LED bulb also has the elastic electric-contact pole which can twist further rotating to get desired orientation, angel, position so the inventor's (1) More than one Level LED bulb (2) Has movable means (3) Elastic electric-contact pole on LED bulb base can get any orientation, position to allow the desired light beams travel to certain areas, location, remote, near by for desired more than one light performance, functions, effects. From FIGS. (5a) (5b) (5c) (5d) can see the movable-means can change the Project light beam away from the center line where has block means (such as lamp shade metal frame) project assembly move by movable-means to away from block-means.

From FIG. 5a) and FIG. 5d) show the inventor's LED bulb has multiple functions and it also may has at least one of the levels or (N-Levels) so can make the LED Bulb's some parts can be movable to other locations in x-y-z axis to away from the any kind of Block means to prevent from any kind of interference from (a) heat (b) light beam traveling (c) signal transmitter such as Wifi, blue-tooth, remote control, infra-red, App software, any kind of electric-wave.

From FIG. 5b) and FIG. 5c) show the Project or light beam away from block-means after use movable-means for the inventor's LED Bulb has (1) more than 1 levels (2) LED bulb has movable means which may any group combination select from bars, rob, pole, hinge, rotating means, spin means, extractable means, extendable means, snake hose, joint means, connect means, joint means, arms, or any other market available means, skill, method to make the unit can make the geometric shape, construction, design to be changed while people use it to overcome the interfered caused by any kind of the said block-means which at least to block the (a) heat (b) light beam traveling (c) Signal transmitting or (d) any other performance, effects, elements want to present by the said LED bulb.

From FIG. 6a show the inventor's LED bulb has more than one level so while the project light beam been blocked by lamp shade's metal frame it can use moveable-means to move the top part of the said inventor's LED bulb to other location so can away from the block-means to let the project light beam can project to the ceiling or desire areas, location, distance which near-by or remote away.

From FIG. 6b show the top view for the 2 parts of the LED bulb. The base is still install inside the lamp holder. But the top parts already away from the center line of socket base so means away from the conventional lamp shade's both the said of metal frame and the center block means.

From FIG. 6c show the more details for the 2 parts LED bulb, the top part and base parts for preferred one of the arrangement which including the top part not only has project assembly but also the other LEDs for glow on desired time, brightness, color, color changing, with other optics means or circuit means, IC means, control means, sensor means, WiFi means, Bluetooth means and any other market available means for LED light functions, effects, performance . . . etc.

From FIG. 6C show the circuit means are inside the base with the channel (here preferred to use the pole as moveable means and center of the pole is empty so can allow the electric wires passing though and arrived the Top part of LED Bulb to offer electric power and signals to the said electric functions needed there.

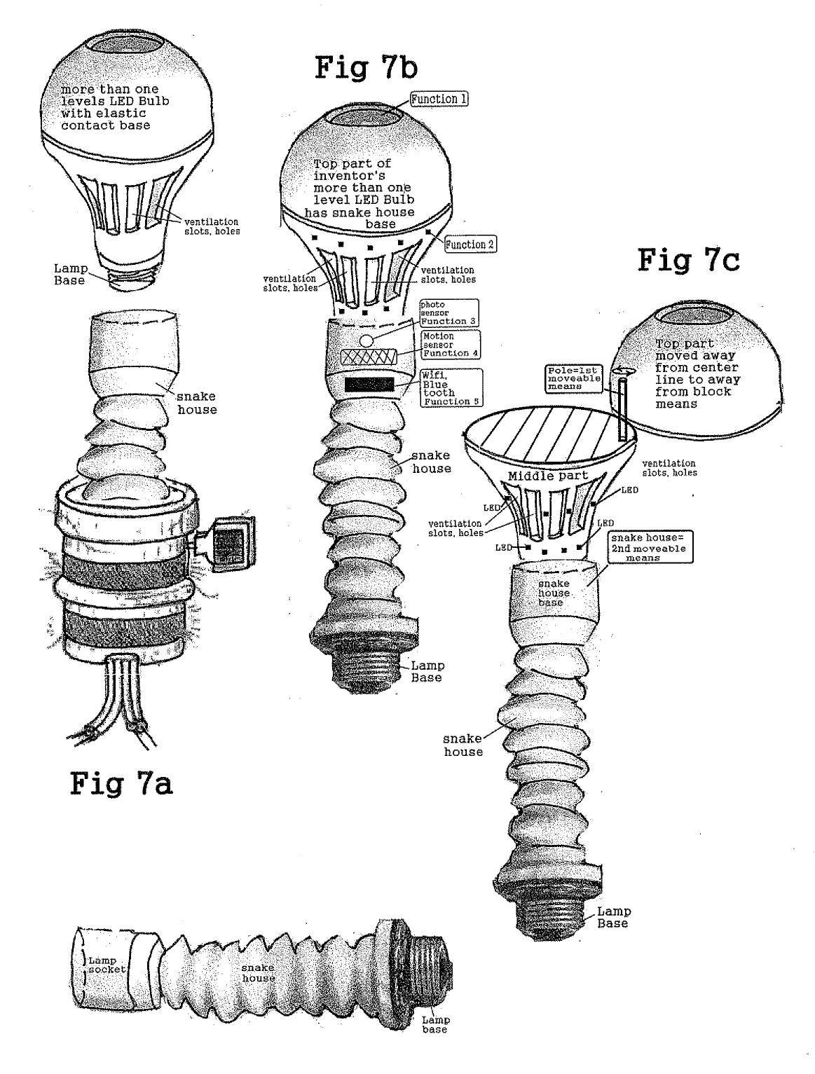

From FIG. 7a and FIG. 7b and FIG. 7c show the LED bulb has moveable-means in the form of snake house so the LED bulb can be moved to any desire location, place, orientations to get good light functions.

From FIG. 7a show a LED bulb has elastic contact base to insert into a separate snake house means so can make the LED bulb to any location wanted.

From FIG. 7b and FIG. 7c LED bulb has built-in snake house movable-means so has the top parts has 1^{st} movable-means and base has 2^{nd} snake house moveable-means so this show the more than one of moveable means for one LED bulb for variety application needed such as outdoor security light to connect with old existing lamp holder for desired light beam emit to certain areas or any other applications.

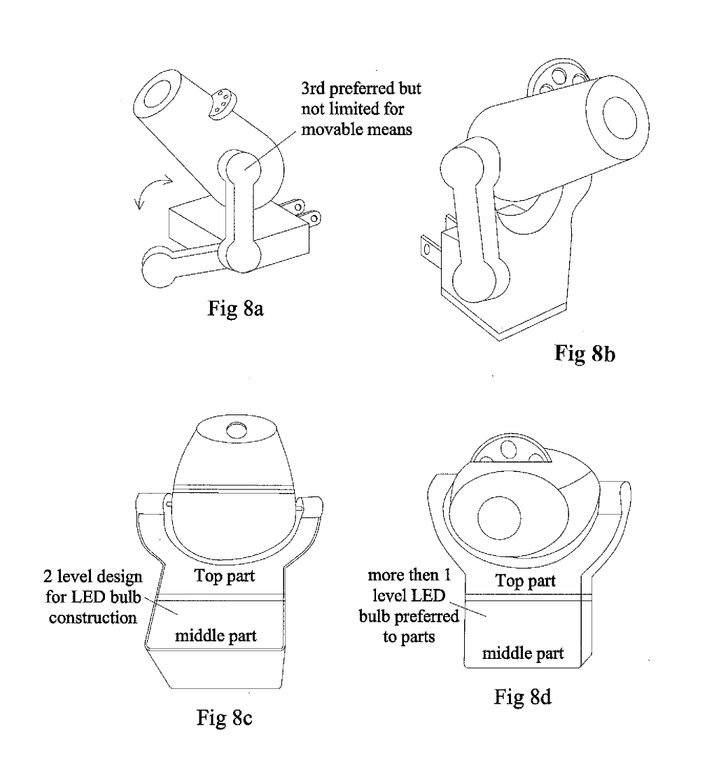

From FIG. 8(a) the moveable means may in group combination select from joint means, join means, spin means, arms means, bar means, rotating means, extend, retractable means, joint means, connector means which can make the parts to change geometric shape, construction, distance, orientation, position, locations all can be consider as movable-means of current invention.

From FIG. 8c and FIG. 8d show The LED Bulb design can has any geometric shape as long as has the bulb base which may use any type available in market place on the body which may including socket base, Pin base, pole base, screw base, pole & twist base, or any base for incandescent bulb been used can be the base for the current invention's LED bulb base.

From FIG. 8a and FIG. 8b show the 3rd preferred but not limited for movable-means. use Arms, rotating means, joint means to make move away from block means.

From FIG. 8c and FIG. 8d show the at least one levels of LED bulb which has preferred top and middle parts for LED bulb. The base can use any conventional base been used for incandescent bulb to Base to become the multiple function LED bulb.

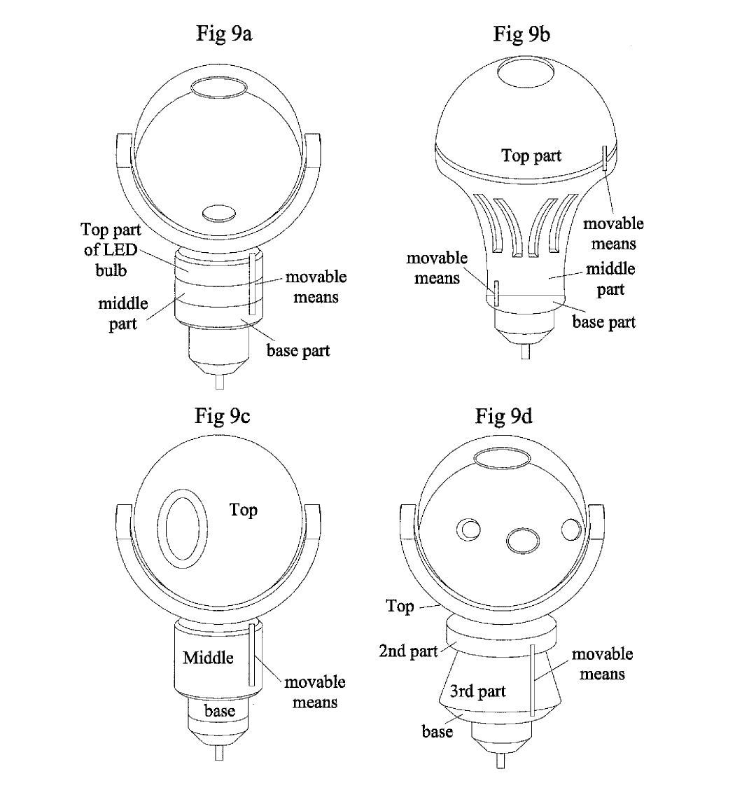

From FIG. 9a and FIG. 9b and FIG. 9c and FIG. 9d, show the multiple levels LED bulb has movable-means to overcome block means and multiple levels each has its own light functions incorporate with market available Wifi, Bluetooth, sensor, switch, App software, remote control, motion sensor for pre-determined functions, determined light functions, effects, performance.

From FIG. 9a and FIG. 9b and FIG. 9c and FIG. 9d show The LED bulbs functions may has any combination for offer near-by or remote away illumination, power fail light, motion sensor light, Wifi remote light, blue tooth sensor light, App software control light, project light, color changing light, multiple color light, reading light, night light, accent light, dot-matrix LEDs light, IC control light or others light functions available from market place.

The current inventions all drawing are same as above listed co-inventor co-pending or patent drawing with some change on the more than one of level LED Bulb and show more details for variety of the moveable-means which can easily find from market available skill or method all fall within the current invention scope not limited for the above disclosure for the arms, snake house, or the movable, rotate, spin, bar, pole . . . etc. So it is easily to refer all these concepts are same but belong to brand new while become the LED bulb applications with all prior arts features and concept. It is appreciated all listed co-pending or patented drawing, concept, feature or equivalent or same functions parts/accessories/electric circuit/concept still fall within the current invention for LED BULB application.

1. The LED Bulb has project functions consist;
At least one LED as light source for project LED bulb.
The LED bulb has more than one level(s) and one of the levels has project related elements within to make the image, message, time, movie, motion picture, digital data, digital image, display-unit(s) to be projected to desired location, surface, area, place at near-by area or remote distance areas.
The project related elements fit within the project-level housing without any electric carry parts or accessories been touch by people.
The others level(s) has at least one of base level which has electric parts and accessories to connect with power source and incorporate with preferred electric components in desire combination selected from circuit means, IC means, switch means, sensor means, wifi means, blue-tooth means, remote control means, App software means, motion sensor means, photo sensor, dimmer means, power fail means, touch means, timer means, countdown means, duration means, other LED(s) means, other light means, Laser means, hologram means, lenticular means, Optics means or any light or optics means for light treatment means available from market available place.
The said LED bulb at least has one movable-means to make at least one of the level to change position to desire location, place, orientation in x-y-z axis.

2. The LED bulb consist of;
At least one of LED as light source.
The LED bulb has more than one level and has at least one of the movable-means to make the said at least one of level of the said LED bulb can change at least one of level position, orientation, location related to other level(s) in x-y-z axis.
The said each level of LED bulb has its light functions has pre-determined functions. Performance, effects.
The said moveable-means may in group combination select from joint-means, join means, rotating means, spin means, hinge mean, bar, pole, connect means, arms, snake-house means, bend-n-shape means, twist means, extractable means, extendable means, foldable means or any market available skill or method to make the at least one of the level to change position, location, orientation in x-y-z axis to overcome the block-means which block the heat flow, the light beam traveling, the electric signals transmitting or other interfering block issues.

3. The LED Bulb consist of;
At least one LED as light source for more than one level(s) LED Bulb.
The More than one Level LED bulbs has more than one functions may selected from group combination including project light, power failure light, color changing light, IC control light, remote control light, infra-red light, motion sensor light, wifi control light, APP software light, blue-tooth light, internet control light, photo sensor light, night light, flashing light, accent light, garden light, solar light, indoor lighting, outdoor lighting, lighting fixture for people to use on desire location, place, area for desired function or functions.
The each level's function, performance, effects as pre-determined and incorporate with related electric parts and accessories to make at least one of LED(s) for light color(s), brightness, duration, cycles, IC control effects which available form market place.

4. The LED Bulb consist of;
At least one of LED as light source incorporate group combination from electric related parts or accessories, circuit means, IC means, switch means, sensor means, wifi means, Blue-tooth means, remote control means, App software means, internet means, elastic contact base, other electric parts or accessories or components available from market place to make the said at least one of LED(s) for pre-determined functions, performance, effects, colors, brightness.
The said LED bulb has more than one level so can move the at least one level or parts or accessories by movable-means to other location, position, orientation or change LED bulb's geometric shape in x-y-z axis.
The each of the level all electric parts and accessories within each level's housing to prevent be touched.

5. The LED Bulb as claim 4, the said movable-means can be desire combination select from joint-means, join means, rotating means, spin means, hinge mean, bar, pole, connect means, arms, snake-house means, bend-n-shape means, twist means, extractable means, extendable means, foldable means or any market available skill or method to make the at least one of the level to change position, location, orientation in x-y-z axis to overcome the block-means which block the heat flow, the light beam traveling, the electric signals transmitting or other interfering block issues.

6. The LED Bulb as claim 4, the said more than one function can be desire combination select from project light, power failure light, color changing light, IC control light, remote control light, infra-red light, motion sensor light, wifi control light, APP software light, blue-tooth light, internet control light, photo sensor light, night light, flashing light, accent light, garden light, solar light, indoor lighting, outdoor lighting, lighting fixture for people to use on desire location, place, area for desired function or functions.

7. The LED Bulb as claim 4, the said electric parts or accessories can be desire combination select from electric related parts or accessories, circuit means, IC means, switch means, sensor means, wifi means, Blue-tooth means, remote control means, App software means, internet means, elastic contact base, other electric parts or accessories or components available from market place

8. The LED Bulb as claim 4, the said more than one level means the Number of level can be from 1 to N (N is any number).

9. The LED Bulb as claim 4, the said LED bulb has more than one level and each level has its own light functions, color, brightness, duration, cycles. moving effects, IC control light effects in group combination selected from sequential, chasing, fade-in and fade out, random flash, freeze one color, changing color, color mixed, Red/Green/Blue mix colors and can incorporated with motor means, spin means, rotating means, movement means, magnetic means, vibration means, optics means, laser means, hologram means, grating means and control means, sensor means, wifi means, bluetooth means, internet means, APP software means to make the each level has desired functions, performance, effects.

10. The LED Bulb as claim 4, the said each level has separate housing and its electric components has carry electricity or signals or current arranged within the said related level housing to prevent from people to touch.

11. The LED Bulb as claim 4, the said each level has related control means to make the each level has preferred functions, effects, performance.

12. The LED Bulb as claim 4, the said each level has its own movable means to make freely move to preferred location, place, orientation in x-y-z axis position.

13. The LED Bulb as claim 4, the said LED bulb may incorporated the adaptor means such as snake house or other lamp holder adaptor has built-in motion sensor, remote control, magnetic means, wifi means, blue-tooth means or any other adaptor means for install between the LED Bulb and lighting lamp socket. The said adaptor has one end for lamp socket to receiving LED bulb base and the other ends are insert the other lamp socket.

14. The LED Bulb as claim 4, the said at least one LED which can be any LEDs or LED array or LED dot-matrix with IC control to get desire light effects in group combination selected from market available light effects including sequential, random, chasing, pair flashing, group flashing, sound activating, fade-in and fade-out, moving has preferred cycles, duty, on-off, time delay which may control by IC, circuit, sound, light or other control means.

15. The LED Bulb as claim 4, the said movable-means which is The parts can be away from the said LED Bulb and has certain configuration and construction to allow install some electric parts & accessories, sensor means, motion sensor means, remote control means, heat sensitive means within so can over come heat, light's shade, light's lens, light's curtain, light's glass, light's cover, cavity's depth, or any other block means.

16. The LED Bulb as claim 4, the said Base of LED bulb can be in any construction including screw type, pins type, poles type, multiple poles type, twist type, bayont type, conventional market type for current invention.

17. The LED Bulb as claim 4, the said project LED bulb has group combination of parts select from LED assembly, LED tubular means, Project means, the construction, parts & accessories which for LED light source so can make the certain LED(s) light beam do not leakage out and passing though the said optics means, optics lens, display unit, image, LCD display image, Lcos image, digital display can be emit out of said LED Bulb to get light beam or image to desire location, position, areas.

18. The LED Bulb as claim 4, the said LED bulb has parts or accessories for desire group combination select from optic means, lens, adjustable focus means, twisted means, rotate means, elastic contact end, more than one output light beam(s), rotating frame, arms, joint means, join means, bulb shade with arms for rotating/tile, more twist bulb base, support for shade, LED assembly, LED tubular means, adjust means, project means, digital data display means, Lcos display means, LCD display means, digital camera means, data storage means, data been projected by optics means, sensor means, switch means, IC means, circuit means, extend means, extractable means, filter means, stencil means, cutout means, painting means, motion sensor means, Remote control means, blue tooth means, Internet wireless means to make the said LED bulb emit the light beams, image, time, data, digital message, internet data(s) to desire near-by area(s) or remote-away distance area(s) for illumination.

19. The LED Bulb as claim 4, the said LED bulb connect with power source by contact means of base in preferred construction and configuration and incorporate with electric parts & accessories to emit the light beam(s) to areas with adjustable angle cover preferred in x-y-z axis or any combination as required for preferred light performance, effects, functions.
